(19) United States
(12) Patent Application Publication
(10) Pub. No.: US 2009/0293346 A1
(43) Pub. Date: Dec. 3, 2009

(54) INTEGRATED REACTOR AND CENTRIFUGAL SEPARATOR AND USES THEREOF

(76) Inventors: Joseph F. BIRDWELL, JR., Knoxville, TN (US); Constantino TSOURIS, Oak Ridge, TN (US); Joanna McFarlane, Oak Ridge, TN (US); Harold L. JENNINGS, Clinton, TN (US)

Correspondence Address: ORNL-UTB-LUEDEKA, NEELY & GRAHAM, P.O. BOX 1871, KNOXVILLE, TN, 37901, US

(21) Appl. No.: 12/128,157

(22) Filed: May 28, 2008

(51) Int. Cl. C10L 1/18; B01J 19/00

(52) U.S. Cl. 44/308; 422/187

(57) ABSTRACT

A method and apparatus for producing a biodiesel product. The method includes continuously contacting a triglyceride containing component with an alcohol and a catalyst at an elevated temperature in a centrifugal reactor/separator. A less dense phase including the biodiesel product is continuously separated from a more dense phase containing glycerine in the reactor/separator.

### GOVERNMENT RIGHTS

This invention was made with government support under Contract No. DE-AC05-00OR22725 awarded by the U.S. Department of Energy. The government has certain rights in the invention.

### TECHNICAL FIELD

The disclosure relates to continuous reactor/separator devices and uses thereof, in particular centrifugal separator/reactors that provide improved residence time for reaction and separation of immiscible liquids from one another.

### BACKGROUND AND SUMMARY

In the current method of manufacture of esterified vegetable oils or animal fats, a feed material containing triglycerides is reacted with a methoxide (typically sodium or potassium methoxide), resulting in the esterification of the glycerides into fatty acid methyl esters. The foregoing process is typically performed in reaction vessels in which the reactants, which are immiscible with one another, are dispersed in one another by stirring or sparging. Upon reaction, the reaction product is a dispersion of two new immiscible liquids, a solution of fatty acid methyl esters and glycerine. In a conventional manufacturing process, the dispersion product of esters and glycerine is separated by centrifugal separation or by the force of gravity by allowing the reaction products to sit undisturbed for approximately 24 hours. The recovered glycerine is disposed of, and the ester product is contacted with water or other aqueous solutions to remove excess reactants and/or unreacted glycerides. The water washing steps may be performed by centrifugal separation or by settling in large tanks that require extensive settling times to allow the wash and product solutions to separate from one another after mixing.

Problems with the foregoing manufacturing process are two fold. First, the effectiveness of the esterification reaction is limited by the extent to which the reactants are intimately mixed with one another and/or reaction kinetics. Consequently, the size of the reactor and the reaction times may be greater than theoretically necessary or the reaction may require a significant excess of methoxide, making purification and recovery of reactants and products more difficult. Secondly, the current state of the art includes several washing and separation steps (processes in which dispersed, immiscible solutions must be allowed to separate over time), each of which is accomplished by gravity settling in large tanks or by the use of conventional centrifugal separation techniques.

Accordingly, there is a need for a more efficient reaction and separation process that provides more intimate mixing of reactants and relatively more rapid separation of the reaction product and reactants and impurities from one another.

With regard to the foregoing, the disclosure provides a method and apparatus for producing a biodiesel product. The method includes continuously contacting a triglyceride containing component with an alcohol and a catalyst at an elevated temperature in a centrifugal reactor/separator. A less dense phase including the biodiesel product is continuously separated from a more dense phase containing glycerine in the reactor/separator.

In an exemplary embodiment, the disclosure provides an apparatus for manufacturing a biodiesel product from triglycerides. The apparatus includes a centrifugal reactor/separator having a stationary shell, a rotating hollow cylindrical component disposed in the stationary shell, a residence-time increasing component between the stationary shell and the hollow cylindrical component, a less dense phase outlet in fluid flow communication with an interior cavity of the hollow cylindrical component; and a more dense phase outlet in fluid flow communication with the interior cavity of the hollow cylindrical component. Storage vessels are provided for reactants in fluid flow communication with the centrifugal reactor/separator. A pump is used for pumping a reactant from the storage vessels to the centrifugal reactor/separator.

In yet another embodiment, the disclosure provides a centrifugal reactor/separator having a stationary shell, a rotating hollow cylindrical component disposed in the stationary shell, a residence-time increasing component between the stationary shell and the hollow cylindrical component, a first outlet in fluid flow communication with an interior cavity of the hollow cylindrical component for a less dense phase fluid, and a second outlet in fluid flow communication with the interior cavity of the hollow cylindrical component for a more dense phase fluid.

An advantage of the embodiments of the disclosure is that it provides a substantially continuous process for reacting and separating immiscible components while providing sufficient reaction time to provide relatively higher yields of product. In the case of biodiesel product manufacture, the apparatus is suitable for providing both the initial esterification reaction and the separation of the ester product and glycerine byproduct from one another in a single mixer/separator device. The apparatus and process therefore reduce the need for large vessels to provide long residence times for reaction and/or for separation of reaction products from byproducts. Multiple centrifugal separator devices may be used to provide purification of the reaction product thereby further reducing the time required for producing such products using conventional distillation, extraction, and/or settling techniques.

### BRIEF DESCRIPTION OF THE DRAWINGS

Further advantages of exemplary embodiments disclosed herein may become apparent by reference to the detailed description of preferred embodiments when considered in conjunction with the drawings, which are not to scale, wherein like reference characters designate like or similar elements throughout the several drawings as follows:

FIGS. 1 and 2 are cross-sectional views, not to scale, of centrifugal reactor/separators according to embodiments of the disclosure; and

FIG. 3 is a schematic illustration of a process according to the disclosure for making a biodiesel product.

### DETAILED DESCRIPTION OF EXEMPLARY EMBODIMENTS

The production of biodiesel products from triglycerides such as vegetable oils and animal fats may be conducted in a variety of ways. However, transesterification of the triglycerides with an alcohol in the presence of an alkoxide catalyst is a useful process for making fatty acid esters that may be used as fuel. According to a particularly suitable process, the following reaction takes place:

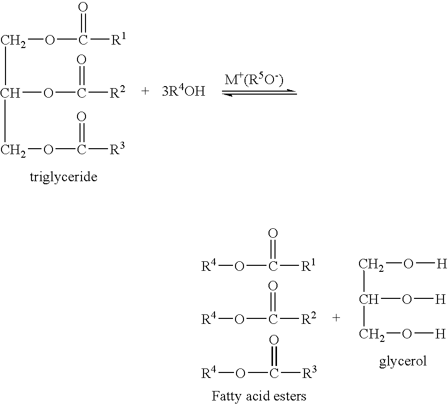

wherein R¹, R², and R³ are hydrocarbyl groups containing from 5 to about 28 carbon atoms, R⁴ and R⁵ are selected from lower alkyl groups containing from 1 to about 4 carbon atoms, and M is a metal selected from sodium, potassium, lithium, rubidium, and cesium, or a lanthanide selected from lanthanum, cerium, praseodymium, neodymium, promethium, samarium, europium, gadolinium, terbium, dysprosium, holmium, erbium, thulium, ytterbium, and lutetium. The foregoing is an equilibrium reaction. Accordingly, the reaction may be forced to the fatty acid ester product by the continuous removal of glycerine from the product.

In an alternative to the above described based-catalyzed reaction, an acid-catalyzed reaction system may be used. Acid catalysts that may be effective to catalyze the transesterification reaction may include, but are not limited to, sulfuric acid, HCl, BF₃, H₃PO₄, and organic sulfonic acids. Although ester hydrolysis can occur by either acid or base catalysis, acid catalysis is generally believed to be more tolerant of moisture and high free fatty acid levels in the starting feedstock and, hence, more suitable for low-grade fats and grease feed stocks. A combination of based-catalyzed and acid-catalyzed reactions may also be used according to embodiments of the disclosure.

The reaction may be conducted at room temperature or at an elevated temperature, typically in the range of from about 25° C. to about 300° C., more typically from about 50° C. to about 150° C. The reaction may be conducted at atmospheric pressure or may be conducted at pressures ranging from about one atmosphere to about ten atmospheres depending on the reactants. If desired, oxygen or inert gases, such as nitrogen or argon may be co-fed with the reactants into the reactor/separator, described in more detail below.

The triglyceride reactant may be obtained from a variety of animal and vegetable sources. For example, a vegetable oil selected from soybean oil, palm oil, palm kernel oil, coconut oil, canola oil, corn oil, cottonseed oil, olive oil, peanut oil, linseed oil, tung oil, sunflower oil, safflower oil, rapeseed oil, sesame oil, Chinese tallow tree oil, Physic nut oil, Cuphea seed oil, babassu oil, perilla oil, oiticica oil, castor oil, microalgal oils, and mixtures thereof may be used as the source of the triglyceride reactant. The triglyceride reactant may also be obtained from animal fats selected from beef tallow, lard, fish oils, menhaden oil, and mixtures thereof, or from uncharacterized waste sources containing the triglycerides.

The alcohol reactant may be a lower alcohol reactant containing from about 1 to about 4 carbon atoms such as methanol, ethanol, propanol, and butanol. A particularly suitable alcohol is methanol. A ratio of alcohol to triglyceride reactant may range from about 3:1 to about 15:1 on a mole basis. However, it is desirable to maintain a nearly stoichiometric molar ratio of alcohol to triglyceride reactant so that separation of the resulting product from the reactants is easier and byproduct volumes are reduced. An advantage of the disclosed embodiments is that operation near the stoichiometric quantity of reactants may be easier to accomplish than with conventional reaction systems.

In base catalysis systems, the catalyst component may be selected from metal alkoxides wherein the alkyl group contains from about 1 to about 4 carbon atoms. Particularly suitable metal alkoxides may be prepared, for example, from sodium methoxide, potassium methoxide and lithium methoxide. An amount of catalyst ranging from about one mole percent to about three mole percent based on the total moles of alcohol plus catalyst may be used.

The fatty acid ester product that is suitable for use as a biodiesel may be a methyl or ethyl ester containing an alkyl chain having from about 8 to about 22 carbon atoms. The product may be saturated or an unsaturated product having a degree of unsaturation ranging from about one to about four.

A key aspect of the foregoing reaction is that the reactants are substantially immiscible in one another. Hence, the rate of mass transfer may be limited by the contact area between the reactant phases resulting in prolonged reaction times. In order to increase the contact area between the reactant phases, the reactants may be agitated or mixed so as to finely disperse one reactant phase into the other reactant phase. In addition, the chemical reaction rate of the components is limited by reaction kinetics. The extent of conversion of reactants into products may be improved by increasing the residence time sufficient to achieve increased conversion of reactants.

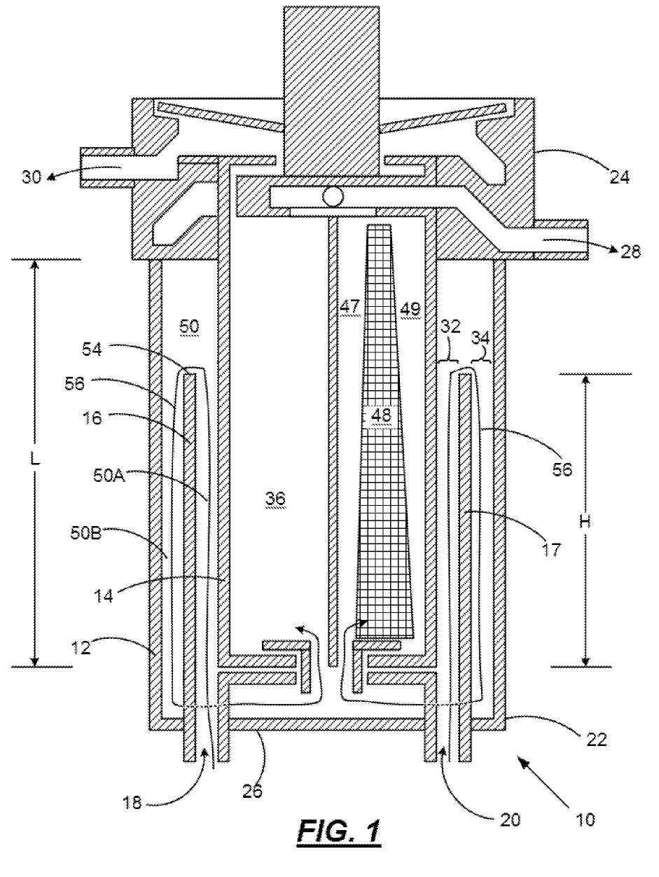

With reference to FIG. 1, an exemplary embodiment of the disclosure provides a centrifugal reactor/separator 10 to accomplish glyceride esterification and recovery of reaction products on a continuous basis with high throughput and a compact size. The reactor/separator 10 includes a stationary shell 12 and a hollow rotor 14 rotatively disposed in the shell 12. In order to provide the reactor/separator 10 according to the disclosure, a conventional separator is modified to include a residence-time increasing component 16 disposed between the shell 12 and the rotor 14. Another modification of the conventional separator is the relocation of fluid inlets 18 and 20 from a position on the shell 12 about midway between a first end 22 and a second end 24 of the separator 10 to a location that is adjacent to the first end 22 of the reactor/separator 10. As shown in FIG. 1, the inlets 18 and 20 are disposed in a bottom portion 26 of the shell 12. However, the fluid inlets 18 and 20 may be disposed on a side wall portion of the shell 12 adjacent to the first end 22 of the separator. Fluid outlets 28 and 30 are adjacent to the second end 24 of the reactor/separator 10, which second end 24 may be provided by using a portion of a conventional centrifugal separator.

In FIG. 1, the residence-time increasing component 16 is a cup-shaped stationary device 17 that is disposed between the shell 12 and the rotor 14 to provide a first gap 32 between the device 17 and the rotor 14 ranging from about 2 to about 130 millimeter. A second gap 34 between the device 17 and the shell 12 is not critical provided the second gap 34 does not significantly impede the flow of fluids into a separating zone 36 of the rotor. The cup-shaped device 17 may have a height dimension (H) that ranges from about 20 to about 90 percent of a length dimension (L) of the rotor 14.

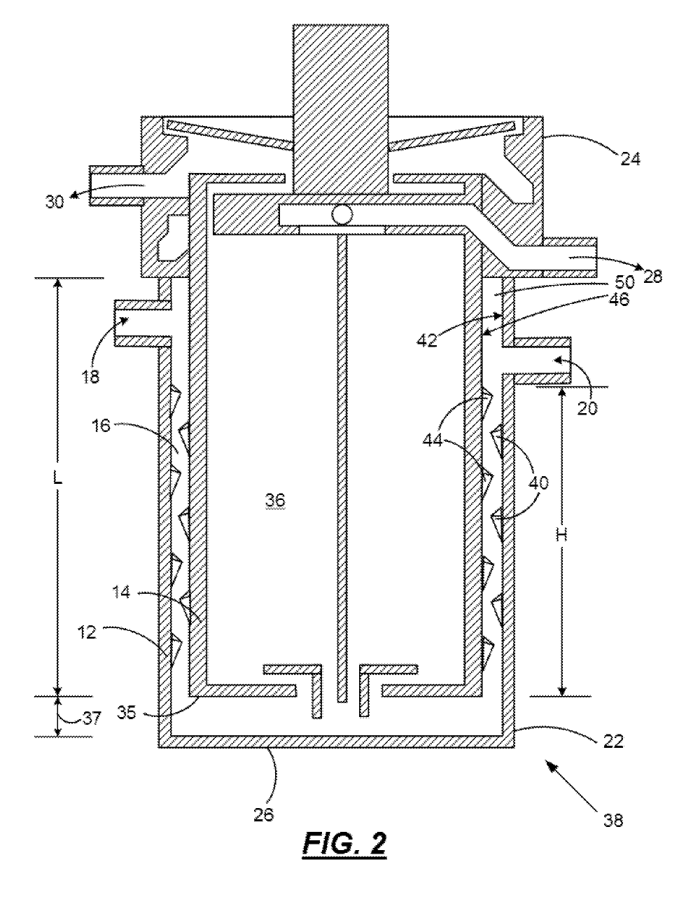

In another embodiment illustrated in FIG. 2, instead of the cup-shaped component 16 illustrated in FIG. 1, a reactor/separator 38 the residence-time increasing component may be a plurality of baffles 40 on an interior wall 42 of the shell 12 and/or baffles 44 on an exterior wall 46 of the rotor 14. An alternative residence-time increasing component may be an interior wall 42 roughness and/or an exterior wall 46 roughness that along with the rotation of the rotor 14 causes turbulent mixing of reactants in a mixing zone 50 between the shell 12 and the rotor 14. Another residence-time increasing component may be selected from baffles on the bottom portion 26 of the shell 12 and a bottom portion 35 of the rotor 14, wall roughness on the bottom portion 26 of the shell and/or on a bottom portion 35 of the rotor 14, and/or a minimized gap 37 between the bottom portion 26 of the shell 12 and the bottom portion 35 of the rotor 14. A combination of two or more of the foregoing residence-time increasing components may be used to further increase residence time without increasing the size of the reactor/separator 10 or 38.

With reference again to FIG. 1, the based catalyzed esterification reaction described above may be conducted by feeding reactants through first and second inlets 18 and 20 into a mixing (contacting) zone 50A of the reactor/separator 10 between the cup-shaped device 17 and the cylindrical hollow rotor 14. During the reaction, the stationary shell 12 may be heated in order to enhance the reaction rate and physical properties of the reactants. As the reaction progresses, reaction products flow into the separating zone 36 provided by a hollow portion of the rotor 14, where dispersed reaction products (e.g., fatty acid esters and glycerine) may be separated from one another by benefit of their disparate densities and centrifugal force. A less dense phase 47 containing the fatty acid ester product flows from central portions of the separating zone 36 into the less dense phase outlet 28. A more dense phase 49 containing the glycerine and byproducts flows from outer portions of the separating zone 36 adjacent the rotor 14 into the more dense phase outlet 30. Between the less dense phase 47 and more dense phase 49, there is a region 48 (represented by cross-hatching) of a mixture of less dense phase 47 and more dense phase 49.

The fatty acid ester product may be purified from unreacted materials or reaction byproducts by multiple sequential contacts with aqueous wash solutions using a similar reactor/separator 10. In the alternative, one or more conventional centrifugal separators may be used to wash and purify the product since residence time is not a factor once the reaction is complete.

Use of the reactor/separator 10 to provide reaction between the triglyceride reactant and the alcohol reactant may significantly increase the reaction efficiency, due to highly efficient mixing of the reactants in the reactor/separator 10 and the increased residence time provided by the residence-time increasing component 16. Separation of the products by centrifugation as they are formed may increase product recovery efficiency and may eliminate a need for large holding vessels, in which the reaction product and byproducts are allowed to separate from one another over extended periods of time. Accordingly, use of centrifugal separation may significantly reduce the size of a production facility required to produce biodiesel at any specific production rate. In addition, use of reactor/separator 10 to provide the various product washing operations used to purify the fatty acid ester product may increase washing efficiency (due to the mixing efficiencies of the devices) and may eliminate the need for large washing vessels. The use of the reactor/separators 10 for the reaction and product separation, and for product washings, facilitates production of biodiesel on a continuous flow basis, which may increase throughput for a facility of a given size and simplify process control during the production of biodiesel products.

While the foregoing exemplary embodiments are based, in part, on the centrifugal solvent extraction contactor, such devices may not provide sufficient residence time for fluids in a mixing zone when two immiscible liquids are contacted with one another, as in the case of biodiesel production. In fact, conventional solvent extraction contactors were designed to provide a minimum of residence time in order to minimize chemical and radiological degradation of organic extractants. However, where increased residence time is required to conduct a reaction or to provide more efficient liquid phase extraction processes, the reactor/separator device 10 as described herein may be particularly useful.

Without desiring to be bound by theoretical considerations, the reactor/separator device 10, according to the disclosure, imparts shear forces on immiscible fluids fed to a narrow annular gap 50 between the stationary shell 12 and rotor 14 enclosed in the stationary shell 12. Shear forces imparted on the fluids in the gap 50 may create a finely divided dispersion via Couette mixing, thereby promoting transfer of solute(s) between phases and reducing mass transfer residence times. The reacted dispersion then passes into the separator zone 36 within the rotor 14 where it is separated into its component liquid phases by centrifugation as described above.

Conventional annular reactors may provide control of reactant residence times by controlling the feed rate of the reaction components to the reactor through fluid inlet ports. However, the residence time in the mixing zone between a rotor and stationary housing in conventional centrifugal contactors is limited and somewhat random. Consequently, obtaining effective mass transfer or accomplishing a chemical reaction in this zone is problematic when the kinetics of the transfer of reactants and products between phases or reactions is relatively slow.

An exemplary embodiment of the disclosure may significantly improve the production of biodiesel products according to the above reaction by conducting the reaction in the centrifugal reactor/separator 10 that includes the residence-time increasing component described above. One means of increasing the residence time is by increasing a pressure drop in a region 50 where reactants flow from inlets 18 and 20 to the regions 50A and 50B between the rotor 14 and the stationary shell 12 then into the separator zone 36 in the rotor 14. Accordingly, fluid hold up in the region 50 may be controlled independent of influent feed rate, in order to provide a residence time required to achieve complete mass transfer between immiscible liquids or conversion of reactive components into products.

With reference to FIG. 2, the pressure drop may be increased by configuring the baffles 40 and/or 44 on the side walls 42 and/or 46 such that the baffles 40 and/or 44 are configured to impede fluid flow into the separator zone 36. Baffles may also be included on the bottom 35 of the rotor 14 and/or on the bottom portion 26 of the shell 12 as described above. Another means of generating an increased pressure drop between the stationary shell 12 and the rotor 14 may be to narrow the annular gap 50 and or 37 between the rotor 14 and stationary shell 12. Still another means of increasing pressure drop between the stationary shell 12 and rotor 14 is to increase the surface roughness of the walls 42 and/or 46.

The stationary, cup-shaped device 17, described with reference to FIG. 1, may be placed within the stationary shell 12 between the rotor 14 and shell 12 such that during rotor 14 operation there is increased fluid turbulence between the rotor 14 and the device 17 in region 50A and a vortex is formed where reactants and product flow into the separator zone 36. The device 17 prevents flow of reactants into the separator zone 36 until liquid reaches a top 54 of the insert 16 and flows through region 50B in the gap 34 between the device 17 and the shell 12, and then into the separator zone 36 as indicated by fluid flow arrows 56. The foregoing configuration may establish a fixed solution hold-up volume in regions 50A and 50B that provide a controllable mean residence time within the reactor/separator 10. The height H of the component 16 may be made larger or smaller depending on the residence time requirements of the reaction being conducted in the reactor/separator 10. Accordingly, the reactor/separator 10 may be designed for easy removal and replacement of the device 17 or the device 17 having concentric slidable walls may be used to increase or decrease the height H of the device 17. The disclosed embodiments are not intended to be limited to the foregoing residence-time increasing components 16, as other suitable components known to those skilled in the art may be used to increase the residence time between the stationary shell 12 and the rotor 14.

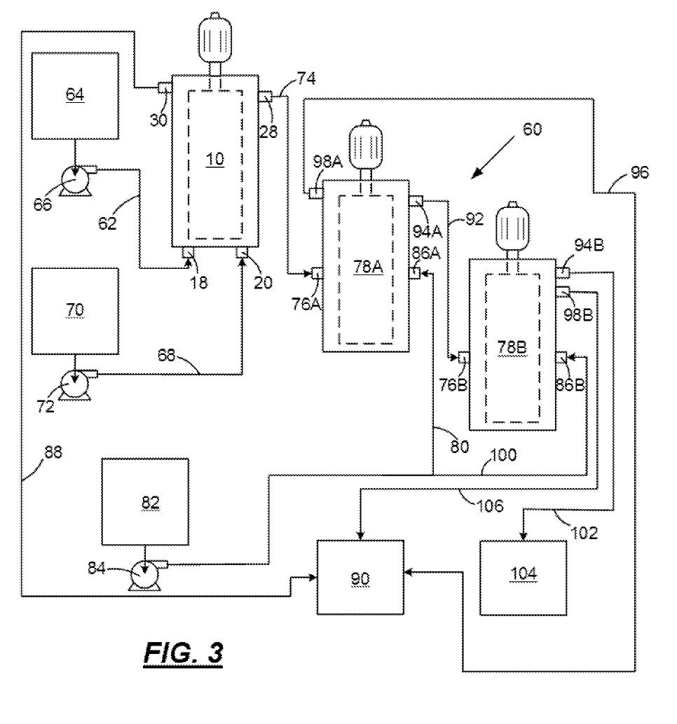

With reference to FIG. 3, there is provided a system 60 for making and purifying a biodiesel product according to an embodiment of the disclosure. According to the system, a triglyceride feed component 62 is fed from a storage vessel 64 by a positive displacement pump 66 into the first inlet 18 of the reactor/separator 10 and an alcohol component 68 containing a catalyst such as a metal alkoxide is fed from a storage vessel 70 by a positive displacement pump 72 into the second inlet 20 of the reactor/separator 10.

After reaction and separation, in the reactor/separator 10, a less dense phase 74 containing the fatty acid ester product may be fed from outlet 28 to a first inlet 76A of a centrifugal separator 78A. Wash water 80 from a wash water storage vessel 82 is fed by pump 84 into the second inlet 86A of the separator 78A for contact with the fatty acid ester product 74. Byproducts and impurities 88 in the more dense phase from reactor/separator 10 are fed from outlet 30 to a byproduct storage vessel 90 for further treatment, recycle, or disposal. The washed product 92 from separator 78A is fed through outlet 94A to a first inlet 76B of a centrifugal separator 78B for further purification and the byproducts and impurities 96 are fed from outlet 98A to the byproduct storage vessel 90. As with separator 78A wash water 100 is fed into a second inlet 86B to contact the washed product 92 from separator 78A. A purified product 102 is fed from outlet 94B into a product storage vessel 104 while the impurities and byproducts 106 are fed from outlet 98B into the vessel 90.

In the foregoing embodiment, the system 60 included one reactor/separator 10 and two centrifugal separators 78. However, the disclosed embodiments are not limited to one reactor/separator 10 and two centrifugal separators 78, as more or fewer reactor/separators 10 and/or centrifugal separators 78 may be used to make a biodiesel product according to the disclosed embodiments. For example, very large reactor/separators 10 may require fewer processing steps to purify the product. Alternatively, the product may be made on a batch basis, wherein intermediate storage vessels are used for byproducts and unpurified products. The unpurified products from the storage vessel may be fed back into the same reactor/separator 10, multiple times for contact with wash water to provide a purified product that is collected in a separator product storage vessel. It will be appreciated however, that the use of the reactor/separator 10 containing the residence-time increasing component enables production of biodiesel products on a substantially continuous basis.

It is contemplated, and will be apparent to those skilled in the art from the preceding description and the accompanying drawings that modifications and/or changes may be made in the embodiments of the disclosure. Accordingly, it is expressly intended that the foregoing description and the accompanying drawings are illustrative of exemplary embodiments only, not limiting thereto, and that the true spirit and scope of the present disclosure be determined by reference to the appended claims.

What is claimed is:

1. A method for producing a biodiesel product comprising:
continuously contacting a triglyceride containing component with a catalyst and alcohol at an elevated temperature in a centrifugal reactor/separator, and
continuously separating a less dense phase comprising the biodiesel product from a more dense phase comprising glycerine in the reactor/separator.

2. The method of claim 1, further comprising continuously contacting the biodiesel product in the centrifugal reactor/separator with an aqueous wash solution and continuously separating a less dense phase comprising a washed biodiesel product from a more dense phase comprising the aqueous wash solution and byproducts.

3. The method of claim 1, wherein the elevated temperature comprises a temperature ranging from about 25° C. to about 300° C.

4. The method of claim 1, wherein the contacting and separating steps are conducted at a pressure ranging from about 1 atmosphere to about 10 atmospheres.

5. The method of claim 1, wherein the triglyceride containing component comprises a vegetable oil.

6. The method of claim 5, wherein the vegetable oil is selected from the group consisting of soybean oil, palm oil, palm kernel oil, coconut oil, canola oil, corn oil, cottonseed oil, olive oil, peanut oil, linseed oil, tung oil, sunflower oil, safflower oil, rapeseed oil, sesame oil, Chinese tallow tree oil, Physic nut oil, Cuphea seed oil, babassu oil, perilla oil, oiticica oil, castor oil, microalgal oils, uncharacterized triglyceride waste oils, waste fatty acids, and mixtures thereof.

7. The method of claim 1, wherein the triglyceride containing component comprises animal fats.

8. The method of claim 7, wherein the animal fats are selected from the group consisting beef tallow, lard, fish oils, menhaden oil, and mixtures thereof.

9. The method of claim 1, wherein the reactor/separator is operated with a rotational speed ranging from about 600 rpm to about 10,000 rpm.

10. The method of claim 1, wherein the biodiesel product comprises fatty acids esters having an alkyl chain containing from about 8 to about 22 carbon atoms

11. The method of claim 1, wherein the centrifugal reactor/separator comprises an annular reaction zone between a stationary component and a rotary component.

12. The method of claim 11, wherein the centrifugal reactor/separator comprises a residence-time increasing component.

13. An apparatus for manufacturing a biodiesel product from triglycerides comprising:
a centrifugal reactor/separator comprising:
a stationary shell;
a rotating hollow cylindrical component disposed in the stationary shell;
a residence-time increasing component between the stationary shell and the hollow cylindrical component;
a less dense phase outlet in fluid flow communication with an interior cavity of the hollow cylindrical component; and
a more dense phase outlet in fluid flow communication with the interior cavity of the hollow cylindrical component;
storage vessels for reactants in fluid flow communication with the centrifugal reactor/separator; and
a pump for pumping reactants from the storage vessels to the centrifugal reactor/separator.

14. The apparatus of claim 13, further comprising product and byproduct storage vessels in fluid flow communication with the centrifugal reactor/separator.

15. The apparatus of claim 13, wherein the residence-time increasing component comprises a cup-shaped cylindrical structure disposed in an annular space between the stationary shell and rotating hollow cylindrical component.

16. The apparatus of claim 15, wherein the annular space between the stationary shell and rotating hollow cylindrical component is sufficient to provide couette mixing of reactants.

17. The apparatus of claim 15, wherein the annular space between the stationary shell and rotating hollow cylindrical component is sufficient to provide residence times ranging from about 5 seconds to about 10 minutes.

18. The apparatus of claim 13, wherein the residence-time increasing component is sufficient to provide residence times ranging from about 5 seconds to about 10 minutes.

19. A centrifugal reactor/separator comprising:
a stationary shell;
a rotating hollow cylindrical component disposed in the stationary shell;
a residence-time increasing component between the stationary shell and the hollow cylindrical component;
a first outlet in fluid flow communication with an interior cavity of the hollow cylindrical component for a less dense phase fluid; and
a second outlet in fluid flow communication with the interior cavity of the hollow cylindrical component for a more dense phase fluid.

20. The centrifugal reactor/separator of claim 19, wherein the residence-time increasing component comprises a cup-shaped cylindrical structure disposed in an annular space between the stationary shell and rotating hollow cylindrical component.

21. The centrifugal reactor/separator of claim 20, wherein the cup-shaped cylindrical structure has a height that ranges from about 20 to about 90 percent of a height of the hollow cylindrical component.

22. The apparatus of claim 20, wherein the annular space between the stationary shell and rotating hollow cylindrical component is sufficient to provide couette mixing of reactants.

23. The apparatus of claim 20, wherein the residence-time increasing component further comprises a component selected from vanes attached to an interior wall of the cup-shaped cylindrical structure, vanes attached to an exterior wall of the hollow cylindrical component, increased side wall roughness of interior walls of the cup-shaped cylindrical structure and exterior walls of the hollow cylindrical component, or a combination of two or more of the foregoing.

24. The apparatus of claim 20, wherein a gap between the cup-shaped cylindrical structure and the hollow cylindrical component ranges from about 2 millimeters to about 130 millimeters.

25. The apparatus of claim 19, wherein the residence-time increasing component comprises a component selected from vanes attached to an interior wall of the stationary shell, vanes attached to an exterior wall of the hollow cylindrical component, increased side wall roughness of interior walls of the stationary shell and exterior walls of the hollow cylindrical component, or a combination of two or more of the foregoing.
